(19) United States
(12) Patent Application Publication
(10) Pub. No.: US 2016/0336606 A1
(43) Pub. Date: Nov. 17, 2016

(54) FUEL CELLS AND METHODS WITH REDUCED COMPLEXITY

(71) Applicants: Intelligent Energy Limited, Loughborough (GB); Commissariat a l'energie atomique et aux energies alternatives (CEA), Paris (FR)

(72) Inventors: Paul Sobejko, Monroe, CT (US); Jeremy Schrooten, Colbert, WA (US); Mauricio Blanco, Vancouver (CA); Vincent Faucheux, Grenoble (FR); Antoine Latour, Grenoble (FR); Jessica Thery, Grenoble (FR); Alain Rosenzweig, Saint Maur des Fosses (FR); Ales Horky, North Vancouver (CA)

(21) Appl. No.: 14/579,669

(22) Filed: Dec. 22, 2014

(51) Int. Cl. H01M 8/0284; H01M 8/2404; H01M 4/86; H01M 8/2465; H01M 8/241; H01M 8/1004

(52) U.S. Cl. CPC H01M 8/0284; H01M 8/241; H01M 8/1004; H01M 4/8605; H01M 8/2465; H01M 8/2404; H01M 2250/30

(57) ABSTRACT

Described herein are methods, articles, and systems relating to planar fuel cells having simplified structures. The planar fuel cells include current collection circuits that are disposed between a planar array of unit fuel cells and associated cover layers. The associated cover layers are porous, dielectric, and define a network of interconnected pores.

### FIELD OF THE INVENTION

The subject matter of the present invention relates to fuel cells having portions of a current collecting circuit disposed between a planar fuel cell assembly and an associated cover layer.

### BACKGROUND

Successive generations of portable electronic devices tend to trend smaller in size while providing increased performance. As electronic components are designed smaller in size and incorporate sophisticated and complex technology, the demands on the associated power supply usually increase. For instance, the power supply may need to occupy less volume or possess a smaller footprint so that the overall device can accommodate the additional technology or decrease in overall size. Further, the additional technology may require that the power supply last for longer periods of time or that power be delivered at uniform rates for steady electronic component performance.

One example of a power supply is a fuel cell system. A fuel cell system may include one or more fuel cell layers, each layer including one or more anodes and cathodes with an electrolyte membrane disposed between the anode(s) and cathode(s). A small, layered fuel cell system must be robust, while accommodating the reduced space requirements.

Maintaining consistent performance of a planar fuel cell across a wide range of operating conditions presents a difficult technical challenge, particularly for systems used in small handheld electronics where space constraints limit the size of the system.

A need exists for small layered fuel cell systems.

### SUMMARY

The present invention relates to methods, articles, and systems relating to planar fuel cells having simplified structures. Specifically, the planar fuel cells include current collection circuits that are disposed between a planar array of unit fuel cells and associated cover layers. The associated cover layers are porous and dielectric.

In some embodiments, the present invention includes a fuel cell assembly comprising a planar array of unit fuel cells a first dielectric cover layer disposed over a first side of the planar array, a second dielectric cover layer disposed over a second side of the planar array opposite the first side of the planar array, and a first portion of a current collecting circuit disposed between the first dielectric cover layer and the planar array. Each unit fuel cell includes an electrolyte layer, a first gas diffusion layer disposed on a first side of the electrolyte layer, and a second gas diffusion layer disposed on a second side of the electrolyte layer opposite the first side of the electrolyte layer. The first dielectric cover layer and the second dielectric cover layer both define a network of interconnected pores. A first portion of a current collecting circuit is disposed between the first dielectric cover layer and the planar array. The first portion of the current collecting circuit contacts the first gas diffusion layer of a plurality of the unit fuel cells. A second portion of a current collecting circuit is disposed between the second dielectric cover layer and the planar array. The second portion of a current collecting circuit contacts the second gas diffusion layer of a plurality of the unit fuel cells.

The invention also includes methods of producing electricity. Such methods include providing a fuel cell assembly of the invention and directing a fuel through the first dielectric cover layer and into contact with the first gas diffusion layer. An oxidant is directed through the second dielectric cover layer and into contact with the second gas diffusion layer.

The invention also includes methods of making a fuel cell assembly of the present invention. The methods include providing a planar array of unit fuel cells by disposing a first gas diffusion layer on a first side of an electrolyte layer and disposing a second gas diffusion layer on a second side of the electrolyte layer opposite the first side of the electrolyte layer; disposing a first portion of a current collecting circuit on the first dielectric layer, wherein the first portion of a current collecting circuit contacts the first gas diffusion layer of a plurality of the unit fuel cells; disposing a second portion of a current collecting circuit on the second dielectric layer, wherein the second portion of a current collecting circuit contacts the second gas diffusion layer of a plurality of the unit fuel cells; disposing a first dielectric cover layer over a first side of the planar array; and disposing a second dielectric cover layer over a second side of the planar array opposite the first side of the planar array, wherein the first dielectric cover layer and the second dielectric cover layer both define a network of interconnected pores.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1A illustrates a cross-sectional view of a prior art fuel cell assembly.

FIG. 1B illustrates an overhead view of an anode current collection layer of a prior art fuel cell assembly.

FIG. 2 illustrates a cross-sectional view of a fuel cell assembly of the invention.

FIG. 3 illustrates an overhead view of an anode current collection layer of the invention.

FIG. 4 illustrates an overhead view of an anode and cathode current collection layer of the invention.

FIG. 5 illustrates an overhead view of a cathode current collection layer of the invention.

FIGS. 6-9 each illustrate a cross-section view of fuel cell assemblies of the invention.

FIGS. 10A-10C illustrate current collection and cover layers of the invention.

FIG. 10D illustrates a cross-section view of a fuel cell assembly of the invention.

FIG. 10E illustrates an overhead view of a fuel cell assembly of the invention.

### DETAILED DESCRIPTION

Throughout the following description, specific details are set forth in order to provide a more thorough understanding of the invention. However, the invention may be practiced without these particulars. In other instances, well known elements have not been shown or described in detail in order to avoid unnecessarily obscuring the invention. The drawings show, by way of illustration, specific embodiments in which the invention may be practiced. These embodiments may be combined, other elements may be utilized or structural or logical changes may be made without departing from the scope of the invention. Accordingly, the specification and drawings are to be regarded in an illustrative, rather than a restrictive, sense.

All publications, patents and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used to include one or more than one, independent of any other instances or usages of “at least one” or “one or more”. In this document, the term “or” is used to refer to a nonexclusive or, such that “A, B or C” includes “A only”, “B only”, “C only”, “A and B”, “B and C”, “A and C”, and “A, B and C”, unless otherwise indicated. In the appended aspects or claims, the terms “first”, “second” and “third”, etc. are used merely as labels, and are not intended to impose numerical requirements on their objects. It shall be understood that any numerical ranges explicitly disclosed in this document shall include any subset of the explicitly disclosed range as if such subset ranges were also explicitly disclosed; for example, a disclosed range of 1-100 shall also include the ranges 1-80, 2-76, or any other numerical range that falls between 1 and 100. In another example, a disclosed range of “1,000 or less” shall also include any range that is less than 1,000, such as 50-100, 25-29, or 200-1,000.

When structures are described herein as being in “direct thermal communication,” it is meant that the structures are in physical contact such that heat may flow between the structures by direct conduction from the first structure to the second structure without the heat having to conduct or flow through any intermediate third structure. For example, if a heat dissipation device is described as being in direct thermal communication with a heat transport device , it means that the heat dissipation device is in physical contact with the heat transport device and that heat can flow between the heat dissipation and transport devices via conduction.

When structures are described herein as being in “indirect thermal communication,” it is meant that the structures are not in physical contact and that any heat from a first structure to a second structure must first be conducted through at least one intermediate structure. For example, if a heat dissipation device is described as being in indirect thermal communication with a planar fuel cell layer, it means that the heat dissipation device is not in physical contact with the fuel cell layer but that heat can flow between the heat dissipation device and the fuel cell layer (e.g., by heat flowing through an intermediate heat transport device that is in direct thermal communication with both the fuel cell layer and the heat dissipation device).

As used herein, “fuel cell” may refer to a single fuel cell, or a collection of fuel cells. The fuel cells may be arranged and connected together, so as to form an array of fuel cells. Arrays of unit cells may be constructed to provide varied power generating fuel cell layers in which the entire electrochemical structure is contained within the layer. Arrays can be formed to any suitable geometry. For example, an array of unit fuel cells may be arranged adjacently to form a planar fuel cell layer. A planar fuel cell layer may be planar in whole or in part, and may also be flexible in whole or in part. Fuel cells in an array can also follow other planar surfaces, such as tubes or curves. Alternately or in addition, the array can include flexible materials that can be conformed to other geometries.

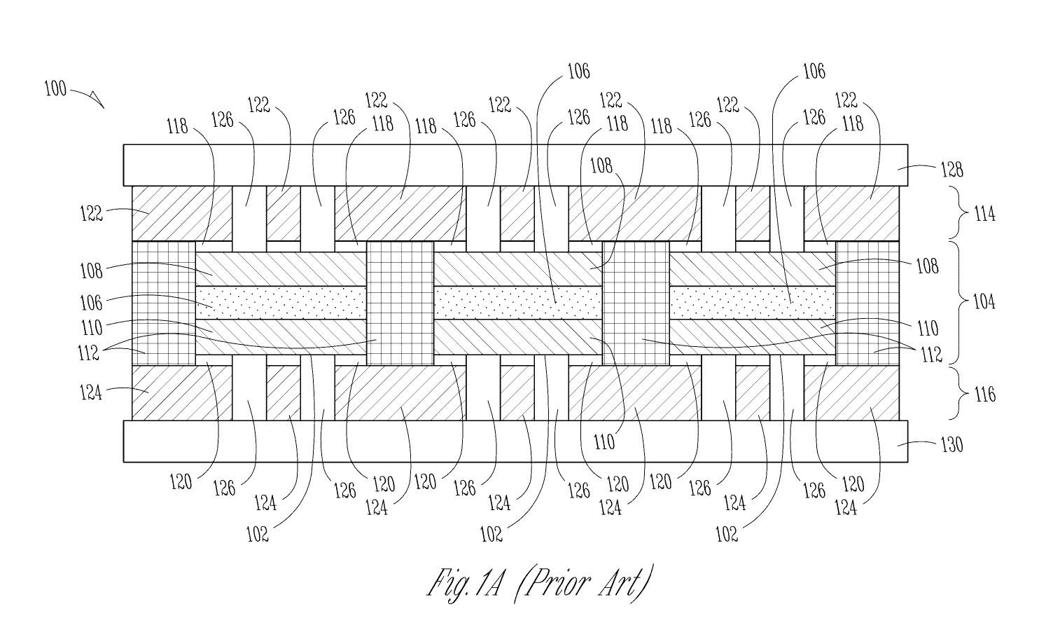

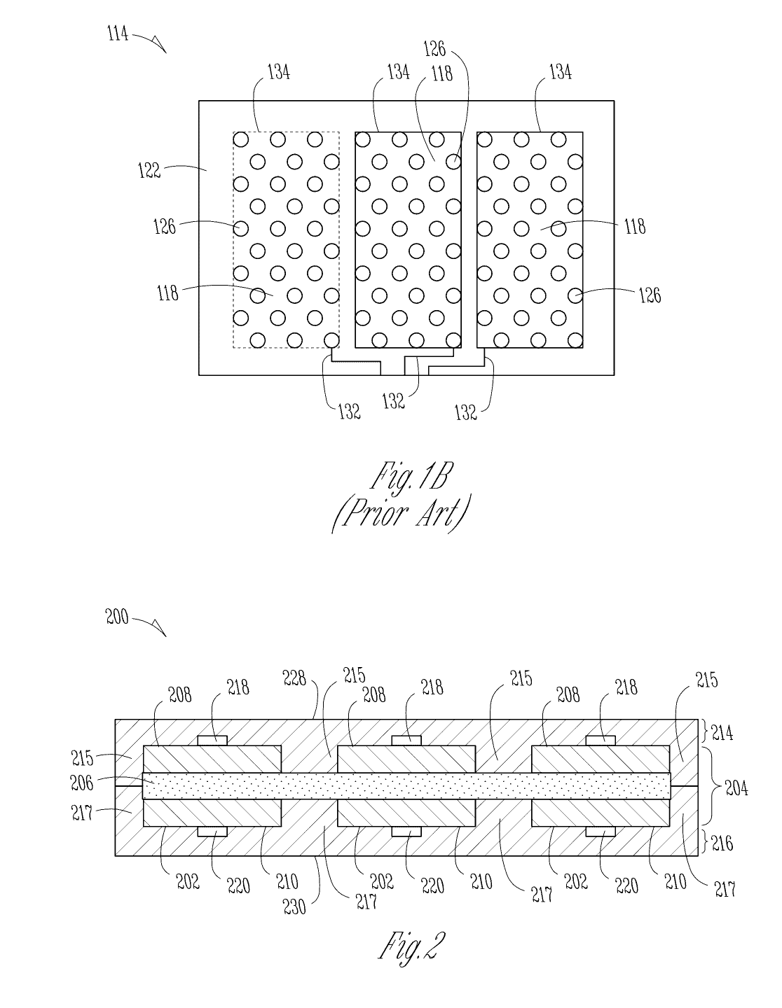

Planar fuel cells typically include a plurality of layers that perform different functions within the cells. FIG. 1A illustrates an example of a cross-sectional view of prior art fuel cell assembly 100. Assembly 100 includes a plurality of membrane electrode assemblies in the form of unit fuel cells 102. Cells 102 are arranged within a plane, forming planar array 104 of fuel cells. Each fuel cell 102 includes an electrolyte layer 106 (e.g., a proton exchange membrane) disposed between two performance enhancing layers in the form of a porous anode gas diffusion layer 108 and a porous cathode gas diffusion layer 110. Each fuel cell 102 can also include a catalyst layer (not explicitly indicated in FIG. 1A) disposed between electrolyte layer 106 and one or both of diffusion layer 108 and diffusion layer 110. The catalyst layers may be located on the surface of the electrolyte layers 106, on the surface of one or both diffusion layers 108 and 110, or on both the surface of the electrolyte layers 106 and one or both diffusion layers 108 and 110. Insulating material 112 is placed between each unit fuel cell 102 and at the ends of planar array 104 to separate and prevent short circuits between the cells 102. In some embodiments, a fuel cell assembly may have a continuous electrolyte layer, which reduces the amount of insulating material needed since the insulating material would be arranged only on the ends of the fuel cell array rather than on the ends and between each unit cell.

Assembly 100 also includes anode current collection layer 114 and cathode current collection layer 116. Anode current collection layer 114 includes anode current collecting circuit 118 disposed on anode current collection substrate 122. Similarly, cathode current collection layer 116 includes cathode current collecting circuit 120 disposed on cathode current collecting substrate 124. Current collection layers 114 and 116 are typically formed from a printed circuit board, with the substrate of the circuit board forming anode and cathode current collecting substrates 122 and 124 and the metal traces of the printed circuit board forming the anode and cathode current collecting circuits 118 and 120. Anode current collecting circuit 118 is in direct contact with, and collects current from, the anode gas diffusion layers 108 of each unit fuel cell 102, while cathode current collecting circuit 120 is in direct contact with, and collects current from, the cathode gas diffusion layers 110 of each unit fuel cell 102. Since the substrate of a printed circuit board is typically made of a non-porous and insulating material, a series of holes 126 or open areas are formed in substrates 122 and 124 to allow the fuel cell reactants and byproducts to flow through layers 114 and 116.

To improve the overall reactant flow and to allow for improved water and thermal management, additional cover layers are used on top of one or both collecting substrates 122 and 124. For example, assembly 100 includes anode dielectric porous cover layer 128 disposed over layer 114 and cathode dielectric porous cover layer 130 disposed over layer 116.

FIG. 1B illustrates an overhead view of anode current collection layer 114. Anode current collection layer 114 includes anode current collecting circuit 118 arranged into three subareas 134 on substrate 122 that correspond to the active area of the three unit fuel cells 102 of assembly 100. A plurality of holes 126 are drilled into substrate 122 to allow for transport of fuel cell reactants and byproducts through layer 114. Current collecting circuit 118 includes three portions 132 that conduct electric current from each of the subareas 134 and electrically connect the current collecting circuit 118 externally or with other portions of assembly 100.

In assembly 100, current collection layers 114 and 116 are used to collect current externally from array 104, thereby allowing the components of array 104 to be made from non-conducting material. However, current collecting substrates 122 and 124 interfere with the flow of reactants and reaction byproducts from or to array 104, and holes 126 placed in layers 114 and 116 to increase these flows consume a relatively large amount of space. Further, assembly 100 requires the use of dielectric porous cover layers 128 and 130 to improve reactant transport and water and thermal management. Hence, assembly 100 tends to be relatively thick due to the use of circuit boards for the current collection layers and the porous external layers.

The present invention combines the function of the current collection layers 114 and 116 and porous cover layers 128 and 130 and reduces the complexity of the overall fuel cell assembly. In some embodiments, the present invention includes an insulating porous material layer that forms the substrate for current collecting circuits, thereby providing a single layer that can both extract current from a planar array of fuel cells and function as a porous cover layer.

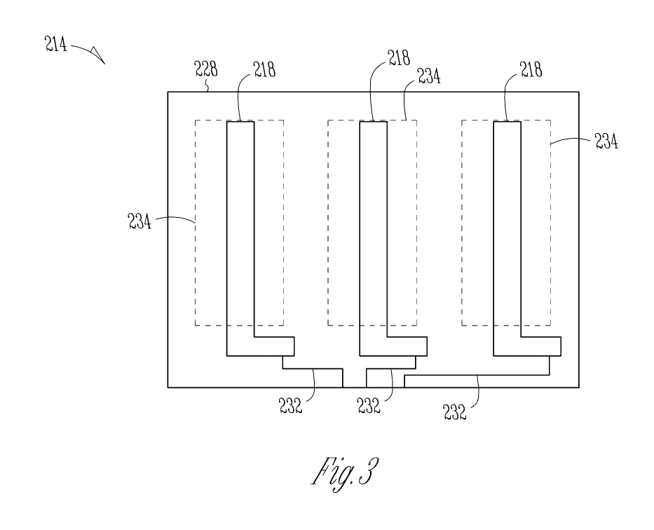

FIG. 2 illustrates one embodiment of the present invention that includes fuel cell assembly 200. Fuel cell assembly 200 includes a plurality of unit fuel cells 202 arranged within a plane, forming planar array 204 of fuel cells. Planar array 204 includes a single continuous electrolyte layer 206 with a plurality of anode electrodes 208, which may optionally include gas diffusion layers and/or performance enhancing layers, disposed on one side and a plurality of cathode electrodes 210, which may optionally include gas diffusion layers, disposed on the opposite side.

Each fuel cell 202 also includes a catalyst layer as part of its electrode (not explicitly indicated in FIG. 2). The catalyst may be disposed as a layer, for example. In embodiments where the anode and/or cathode electrodes 208/210 include gas diffusion layers, the catalyst may be disposed between electrolyte layer 206 and one or more of the gas diffusion layers. The catalyst layers can be attached to or located on either the surface of electrolyte layer 206 or the respective gas diffusion layers to form anode and cathode electrodes 208 and 210, respectively. If catalyst layers are attached to or located on the surface of electrolyte layer 206, the catalyst layers can be placed at the positions on electrolyte layer 206 that are separate from one another, thereby providing an electrical break between individual unit fuel cells 202. If electrodes 208 and 210 include electrically conductive gas diffusion layers or performance enhancing layers, they may be aligned with the catalyst layers to preserve the electrical break between adjacent unit fuel cells 202.

Anode and cathode gas diffusion layers or performance enhancing layers may be made out of carbon fiber papers or out of a combination of conductive materials and a binder. In further embodiments of the invention, the diffusion layers 208 and 210 include the same features as the performance enhancing layers described in PCT App. No. PCT/CA2010/002026 which was published as PCT Publication No. WO2011/079378 on Jul. 7, 2011, the entire disclosure of which is incorporated herein by reference. In some embodiments, the anode and cathode layers 208 and 210 may include material to enhance the electrical conductivity across the surface of the unit fuel cell, for example, a thin, porous layer of a noble metal (e.g., gold or silver) or materials such as carbon nanotubes. Further examples of such layers may also be found in U.S. patent application Ser. No. 12/275,020, which was filed on Nov. 20, 2008 and published as U.S. Patent Application Publication 2009/0130527 on May 21, 2009, the disclosure of which is incorporated herein by reference in its entirety

Fuel cell assembly 200 also includes anode current collection and cover layer 214 and cathode current collection and cover layer 216 disposed on the outer surfaces of the anode electrodes 208, the cathode electrodes 210, and the electrolyte layer 206. Anode current collection and cover layer 214 includes anode current collecting circuit 218 and anode dielectric porous cover layer 228. Cathode current collection and cover layer 216 includes cathode current collection circuit 220 and cathode dielectric porous cover layer 230. As in assembly 100 in FIG. 1A, current collecting circuits 218 and 220 of assembly 200 are connected to an external portion of an electrical circuit in order to extract the current produced by planar array 204, such as a circuit providing power to an electronic device. Anode and cathode dielectric porous cover layers 228 and 230 envelope and contact each unit fuel cell 202. Portions 215 and 217 of layers 228 and 230, respectively, may extend between and interdigitate unit fuel cells 202.

FIG. 3 illustrates an overhead view of anode current collection and cover layer 214. Anode current collection and cover layer 214 includes anode current collecting circuit 218 spanning down the center of the three subareas 234 on anode dielectric porous cover layer 228 that correspond to the active surface area of the unit fuel cells 202 of assembly 200. Current collecting circuit 218 includes three portions 232 that conduct electric current from or to each of the subareas 234 and electrically connect the anode current collecting circuit 218 externally or with other portions of assembly 200.

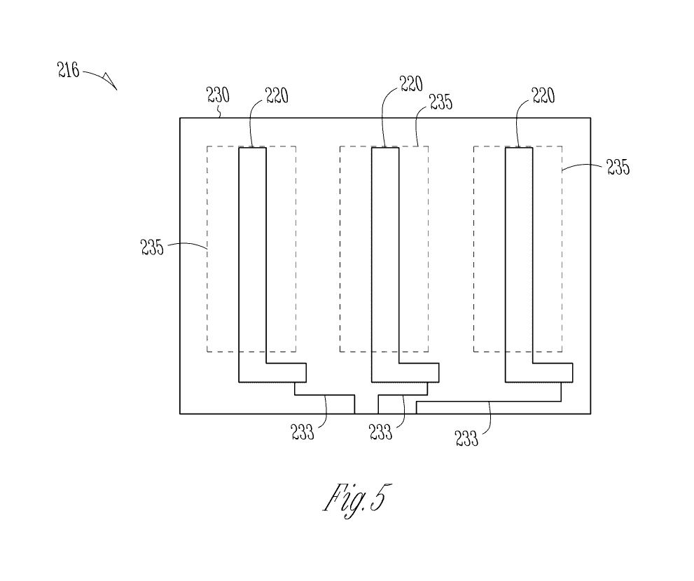

FIG. 5 illustrates an overhead view of cathode current collection and cover layer 216 which is similar in most regards to anode current collection and cover layer 214. Cathode current collection and cover layer 216 includes cathode current collecting circuit 220 spanning down the center of three subareas 235 on cathode dielectric porous cover layer 230 that correspond to the active surface area of the unit fuel cells 202 of assembly 200. Current collecting circuit 220 includes three portions 233 that conduct electric current from or to each of the subareas 235 and electrically connect the cathode current collecting circuit 220 externally or with other portions of assembly 200.

In assembly 200, current collection and cover layers 214 and 216 are used to collect current externally from array 204, thereby allowing the components of array 204 to be made from non-conducting material. One or both of current collection and cover layers 214 and 216 define a network of interconnected pores that provide for the flow of reactants and reaction byproducts from or to array 204 without the use of large surface-consuming holes. Hence, assembly 200 tends to be relatively thin because it does not require a separate circuit board substrate layer.

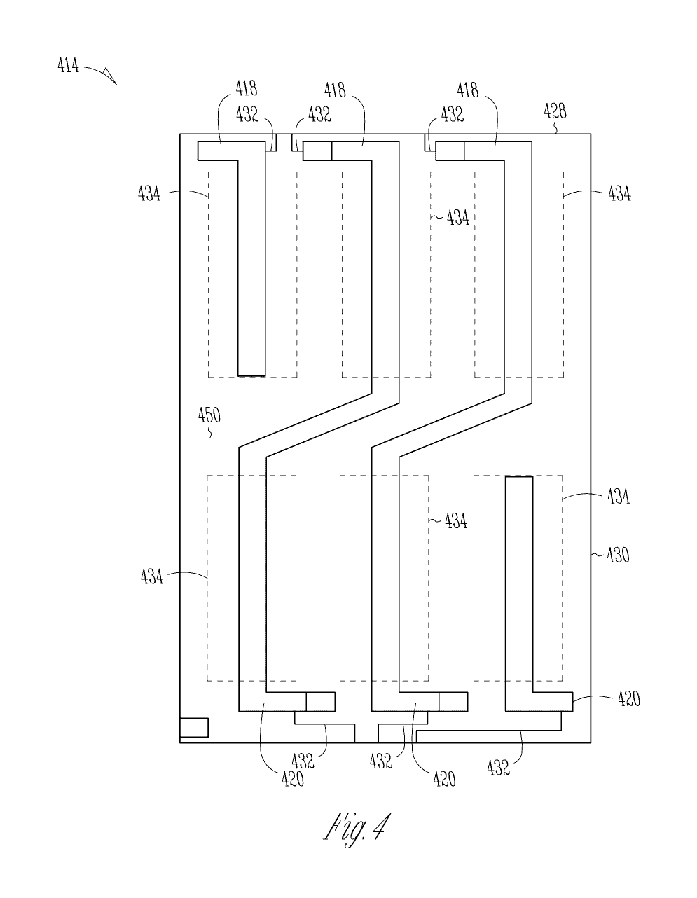

FIG. 4 illustrates an overhead view of another embodiment of the invention that includes anode and cathode current collection layer 414. Anode and cathode current collection layer 414 is large enough to fold along midline 450 such that it can envelope a planar fuel cell array. In this manner layer 414 provides for both current collection layers of a planar fuel cell array. The upper half of layer 414 above midline 450 forms an anode dielectric porous cover layer 428 with the associated portions of an anode current collecting circuit 418 spanning down the middle of subareas 434 that correspond to the active anode areas on a planar fuel cell array. The lower half of layer 414 below midline 450 forms a cathode dielectric porous cover layer 430 with the associated portions of a cathode current collecting circuit 420 spanning down the middle of subareas 434 that correspond to the active cathode areas on a planar fuel cell array. Portions 432 of the anode and cathode current collecting circuit 418 and 420 provide for external electrical communication with an outside electronic device of other portions of a fuel cell assembly. Anode and cathode current collection layer 414 connect all of the unit fuel cells of a cell assembly into a series configuration. In other embodiments, the current collection layer is configured so as to place some or all of the unit fuel cells of a fuel cell assembly into an electrically parallel arrangement. Anode and cathode current collection layer 414 provides for an even simpler method of constructing a fuel cell assembly of the present invention in that a planar fuel cell array can be enveloped by a single portion of material that fold over a planar fuel cell array to form the current collection layers on both sides of the array.

In some embodiments of the invention, the anode and cathode cover layers (e.g., layers 228 and 230) are formed of a porous and dielectric material, such as PTFE, Teflon® (available from E.I du Pont de Nemours and Company, Corp. of Wilmington, Del.), polypropylene, polyethylene, FEP, nylon, or polyester. In some embodiments, anode and cathode cover layers 228 and 230 are relatively thin to reduce the overall thickness of fuel cell assembly 200. In further embodiments, anode and cathode cover layers 228 and 230 are made of a material that does not shrink or expand when exposed to water vapor and/or temperatures between about −40° C. and about 120° C. For example, layers 228 and/or 230 may be configured so that they expand and contract by less than 2 or 3 percent within this temperature range. Additionally, layers 228 and 230 are, in some embodiments, formed of a material that is chemically stable when exposed to an acidic environment. Further, layers 228 and 230 are not themselves formed of a material that will corrode other portions of fuel cell assembly or contaminate catalyst layers or the electrolyte layer. In yet further embodiments; anode and cathode cover layers 228 and 230 are made of a material that allows for reactant flow towards planar array 204 or fuel cell reaction byproducts to flow away from planar array 204 (e.g., towards the outside environment) to improve performance of the fuel cells 202 and the overall water management of assembly 200. For example, the anode and/or cathode cover layers may be made of sheets of a polymeric material (e.g., an ultra-high molecular weight polyethylene sheet) or a fibrous material (e.g., woven clothes, felts or paper). In some embodiments one or both cover layers are formed from a hydrophilic material.

In some embodiments, the anode and/or cathode cover layers are between about 100 and about 200 82 m thick, with the layers possessing enough material to distribute a desired amount of heat along the surface of the fuel cell evenly and efficiently. In further embodiments, the anode and/or cathode cover layers define a network of interconnected pores that form between about 80% and 90% of the volume of the layer with an average pore diameter size of less than about 100 μm.

In some embodiments, the anode cover layer may have different physical characteristics than the cathode cover layer because the demands of a specific application have disparate requirements of an anode cover layer compared to the cathode cover layer. For example, in some embodiments of the invention, an anode cover layer may be less porous than a cathode cover layer because the reactant on the anode side may be a small particle (e.g., hydrogen) that diffuses through materials faster than the oxidant (e.g., atmospheric oxygen) diffuses through a cathode cover layer. In another example, an anode cover layer may be subjected to a more demanding mechanical tension than a cathode cover layer. In such an embodiment, the anode cover layer may be made of a stronger material, a less porous material, and/or a thicker material compared to the cathode cover layer.

There are a number of ways the fuel cell assembly of the current invention may be constructed. In some embodiments, the planar array of unit fuel cells is bonded or coupled with an anode and/or cathode current collection layer via lamination, bonding, spraying, or any other layering method known in the art. Such a bonding procedure conforms a porous cover layer to the shape of the planar array of unit fuel cells, thereby providing for good electrical connection between each unit fuel cell and its associated portion of a current collecting circuit. In addition, such a bonding process eliminates the amount of open spaces between a cover layer and the planar array of unit fuel cells thereby facilitating the flow of reactants and/or byproducts to or from the unit fuel cells. In some embodiments, the catalyst layer is to the anode and/or cathode current collection layer before or at the same time as said collection layer is bonded to the planar array of unit fuel cells.

As an example, the fuel cell assembly illustrated in FIG. 2 may be constructed in a number of ways. While much of the below assembly description references the anode side of fuel cell assembly 200, the same procedures or processes can be used to construct the corresponding portions of the cathode side of fuel cell assembly 200.

In some embodiments, a catalyst layer is directly deposited onto an electrolyte to create a catalyst-coated electrolyte membrane. Examples of suitable direct deposit techniques can include spraying, screen printing, sputtering, dipping, ink-jet printing, sputtering, or any other suitable known direct deposition method. In other embodiments, the catalyst layers are deposited on the inner surface of the anode gas diffusion layer (i.e., the surface disposed against electrolyte 206) to create a gas diffusion electrode using the same direct deposition methods. Gas diffusion electrodes 208 and electrolyte layer 206 can then be bonded or laminated together via a press or rollers. In some embodiments, bonding or laminating layers 208 with layer 206 may include simultaneous heating or one or both layers.

In some embodiments, the various portions of anode current collecting circuit 218 are attached to anode dielectric porous cover layer 228 using an adhesive or epoxy to form the anode current collection layer 214 and then laminating layer 214 to planar array 204. In some embodiments, the adhesive is of a type that is electrically conductive (e.g., a silver filled epoxy) is placed between current collecting circuit 218 and cover layer 228 to ensure good electrical contact. In other embodiments, current collection layer 160 is an adhesive backed metal foil (e.g., copper tape) that is adhered to cover layer 228. The resulting anode current collection layer 414 can then be laminated to planar array 204 of unit fuel cells 202. Laminating planar array 204 to unit fuel cells 202 may include the use of a conductive adhesive (e.g., a silver filled epoxy) to ensure good electrical contact between anode current collecting circuit 218 and anode gas diffusion layer 208. In other embodiments of the invention, current collection circuit 218 is formed by a conductive epoxy that is screened or stencil printed onto anode dielectric porous cover layer 228. The cover layer and epoxy circuit assembly is then laminated to planar array 204 to create fuel cell assembly 200. It may be necessary to cure the epoxy before laminating, or the epoxy may be cured at the same time as lamination onto array 204. In further embodiments of the invention, anode current collecting circuit 218 may be placed on anode dielectric porous cover layer 228 via a physical deposition method (e.g., sputtering or spray deposition) that lays a conductive material onto layer 228. The resulting cover layer and circuit assembly can then be laminated to planar array 204. Again, in some embodiments, a conductive adhesive (e.g., a silver filled epoxy) may be placed between circuit 228 and planar array 204 to ensure a desirable amount of electrical contact.

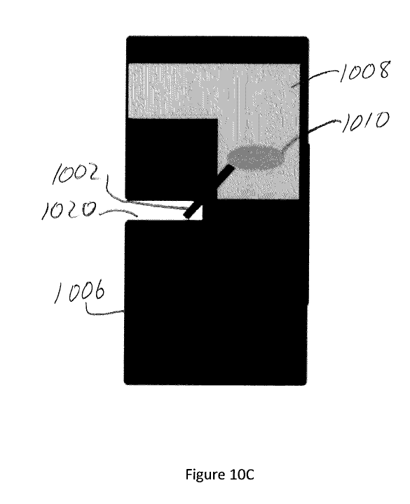

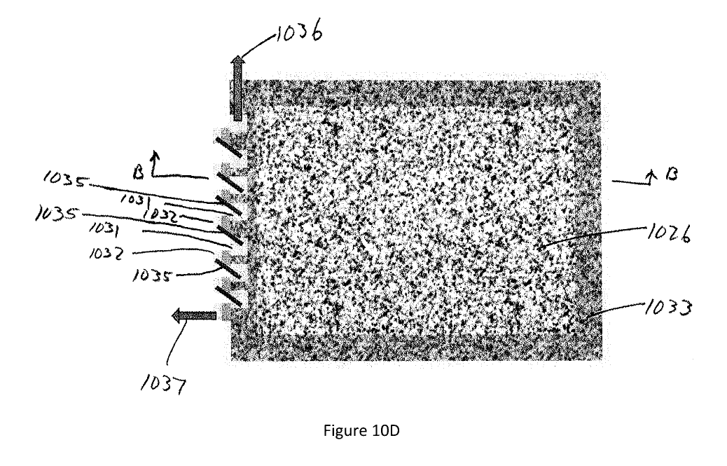

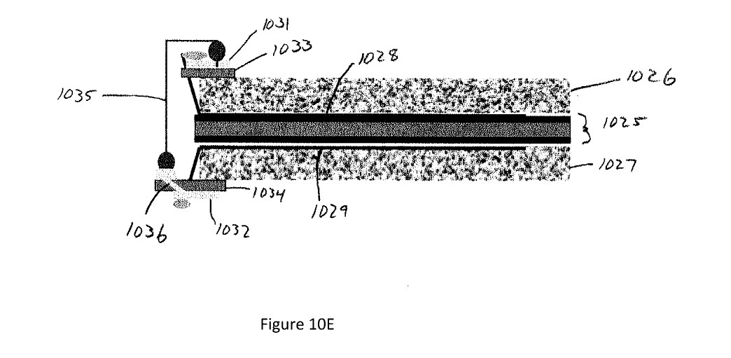

In some embodiments of the invention, the current collection and cover layers include one or more wires bonded to one or both sides of a substrate layer onto which is secured a printed circuit board (PCB). FIGS. 10A and 10B illustrate such an embodiment in the form of current collection and cover layer 1000. FIG. 10A illustrates a top view of layer 1000, while FIG. 10B illustrates a cross-sectional view along line AA in FIG. 10A.

Layer 1000 includes a plurality of wire current collectors 1002 and 1003 secured to inferior side 1005 of substrate layer 1004. Layer 1000 also includes PCB 1006 (printed circuit board 1006) which is secured to superior side 1007 of substrate layer 1004. Substrate layer 1004 can be formed of any suitable material that provides the desired water management properties for a given application. For example, substrate layer 1004 may be formed from an open or porous mesh material or paper, or any of the other materials of construction for the cover layers described herein.

As shown best in FIG. 10B, wire current collectors 1002 and 1003 are bonded (either mechanically or via heat bonding) onto or partially into inferior side 1005 of substrate layer 1004. As used herein, the “inferior side” of the substrate layer is that side which will be disposed facing and/or touching the planar array of fuel cells (also sometimes referred to as the “membrane electrode assembly” or “MEA”) while the “superior side” of the substrate layer is that side that will face away from the planar array of fuel cells. The wire current collectors 1002 and 1003 may be made of corrosion resistant metal, such as gold wire, gold coated wire, silver wire, or other corrosion resistant alloys that will withstand the operating conditions of the planar array of fuel cells. In some embodiments, the current collectors are shaped as ribbons.

PCB 1006 is secured to superior side 1007 of substrate layer 1004. The PCB may be secured to all or only a portion of the superior side of the substrate layer. In some embodiments, such as that shown in FIG. 10A, PCB 1006 is secured around the perimeter of superior side 1007 of substrate layer 1004, thereby “framing” the layer 1000. PCB 1006 includes traces 1008, which provide electrically conducting pathways. PCB 1006 may be a thin-form factor to compensate for the thickness of the porous substrate layer 1004. While FIG. 10B illustrates PCB 1006 as underlying traces 1008 and disposed between traces 1008 and superior side 1007 of substrate layer 1004, in some embodiments traces 1008 are disposed between PCB 1006 and superior side 1007 of substrates layer 1004.

As best illustrated in FIG. 10B, wire current collectors 1002 and 1003 extend around the lateral side of substrate layer 1004 and are secured to PCB 1006 at connection points 1010 on superior side 1007. Wire current collectors 1002 and 1003 are thereby in direct electrical communication with traces 1008 of PCB 1006. In some embodiments, the wire current collectors also extend around the opposite lateral side of the substrate layer and are secured to PCB on side of the PCB “frame” opposite the side having the traces, thereby providing the wire current collectors with two points of attachment to PCB and greater structural support.

In some embodiments, notches may be formed in the sides of PCB 1006 and/or substrate layer 1004 to better accommodate wire current collectors 1002 and 1003. FIG. 10C illustrates such an embodiment, with a close-up view of the edge of the superior side of PCB 1006 which includes notch 1020 providing for easier or improved wrapping of wire current collector 1002 around the lateral side of PCB 1006. Wire current collector 1002 extends through notch 1020 and is secured to traces 1008 of PCB 1006 at connection points 1010. In still further embodiments, wire current collector 1002 may be attached to the inferior side of PCB 1006, or may be attached to PCB 1006 through vias, or through-holes in the PCB.

Current collection and cover layer 1000 provides a number of advantageous features and may be used as the cover layer for any of the fuel cell system embodiments described here. PCB 1006 provides layer 1000 with structural support. Further, if traces 1008 are arranged on superior side 1007, the traces 1008 will face away from the MEA and are therefore protected from the sometimes corrosive operating conditions of the unit fuel cells making up the MEA. The corrosion-resistant wire current collectors 1002 and 1003, on the other hand, provide good conduction of the electric current from the unit cells to the traces 1008.

Traces 1008 can further serve as electrical connection points for connecting the fuel cell assembly with other fuel cell assemblies or with larger electric circuits. For example, the traces 1008 secured directly to wire current collectors 1002 may be in turn connected to adjacent fuel cells or fuel cell arrays, while the traces 1008 secured directly to wire current collectors 1003 may be electrically connected to systems that utilize the power produced by the fuel cells (e.g., portable electronic devices).

FIGS. 10E and 10D illustrate how traces can serve as electrical connection points for connecting the fuel cell assembly with other fuel cell assemblies and with larger electric circuits. As shown in FIG. 10E, MEA layer 1025 is sandwiched between two substrate layers 1026 and 1027. Wire collectors 1028 and 1029 are disposed along opposing faces of MEA 1025 and substrate layers 1026 and 1027, respectively. In this way, wire collectors 1028 and 1029 are positioned to provide current extraction along the length of the unit cell(s) in MEA layer 1025.

Wire collector 1028 is in direct electrical communication with traces 1031 of PCB 1033 while wire collector 1029 is in directed electrical communication with traces 1032 of PCB 1034. An electrical connection 1035 is positioned to connect traces 1031 of PCB 1033 with traces 1032 of PCB 1034. A thru-board trace 1036 runs across PCB 1034 to electrically connect trace 1032 with electrical connection 1035. While not illustrated in FIG. 10E, a similar thru-board trace may also run across PCB 1033 to electrically connect trace 1031 with electrical connection 1035. Electrical connection 1035 between traces 1031 and 1032 may be achieved in a number of ways, including direct soldering, wire bonding, via wielding methods, or conductive adhesives.

FIG. 10D illustrates an overhead view of the embodiment illustrated in FIG. 10E (where FIG. 10E is a cross-section view along line BB in FIG. 10D). As seen in FIG. 10D, substrate 1026 may be positioned relative to substrate 1027 such that traces 1031 of PCB 1033 and traces 1032 of PCB 1034 are somewhat off-set from each other so as to make electrical connection easier (for clarity, only a few of the traces 1031, traces 1032, and electrical connections 1035 are numbered in FIG. 10D). In this way, neighboring unit cells of MEA layer 1025 are connected in series across the fuel cell layer with the anode of one cell electrically connected to the cathode of a neighboring cell. Main current extraction points 1036 and 1037 provide connection points for connecting PCB 1033 and 1034, respectively, with external electrical systems.

In some embodiments of the invention, the current collecting circuit is disposed on the anode or cathode collection layers using the same techniques that are utilized in forming circuits on the substrate of a circuit board. The current collecting circuit should be made of a conductive metal that does not corrode or/and contaminate the unit fuel cells when exposed to acidic conditions, or else be protected against such corrosion via protective coatings or other equivalent means.

The size, thickness, and patterns for the current collecting circuits depend on the size of each single cell fuel cell used in the overall fuel cell system. In some embodiments, each trace of a current collecting circuit is on the order of about 1.5 mm wide and about 20 μm thick.

In some embodiments of the invention, gaskets (not shown in the Figures) may also be used in the outside perimeter of the current collection and cover layer in order to eliminate any leaks.

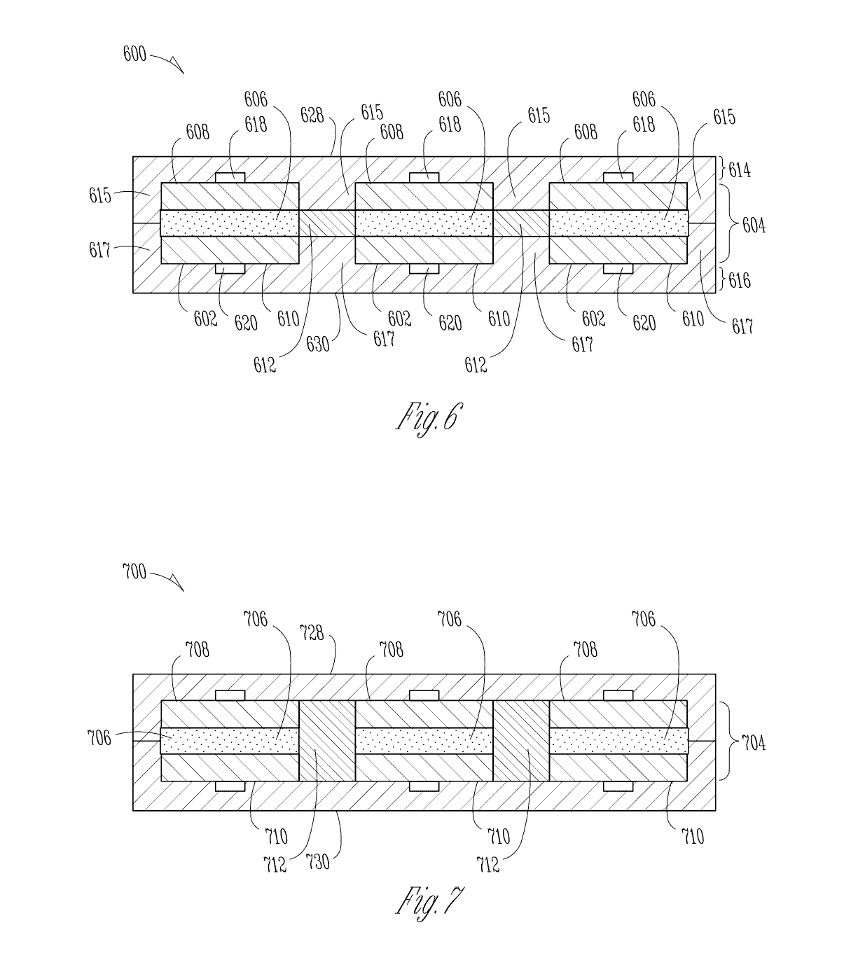

FIG. 6 illustrates another embodiment of the present invention that includes fuel cell assembly 600 which is similar in many response to fuel cell assembly 200 shown in FIG. 2. While assembly 200 includes a single continuous electrolyte layer 206, fuel cell assembly 600 includes a series of discontinuous electrolyte layers with insulating material portions positioned between the unit fuel cells.

Fuel cell assembly 600 includes a plurality of unit fuel cells 602 arranged within a plane, forming planar array 604 of fuel cells. Planar array 604 includes a plurality of electrolyte layers 606 with a plurality of anode gas diffusion layers 608 disposed on one side of each electrolyte layer 606 and a plurality of cathode gas diffusion layers 610 disposed on the opposite side of each electrolyte layer 606. Insulating material portions 612 are positioned between and separate each electrolyte layer 606.

Each fuel cell 602 also includes a catalyst layer (not explicitly indicated in FIG. 6) disposed between electrolyte layers 606 and one or more of the gas diffusion layers 608 and 610. The catalyst layers can be attached to or located on either the surface of electrolyte layer 606 or the respective gas diffusion layers 608 and 610. If attached to or located on the surface of electrolyte layer 606, the catalyst layers can be placed at the positions on electrolyte layer 606 that are in contact with a gas diffusion layer 608 or 610, thereby providing an electrical break between individual unit fuel cells 602.

Anode gas diffusion layers 608 and cathode gas diffusion layers 610 can be made out of carbon fiber papers or out of a combination of conductive materials and a binder. In further embodiments of the invention, the diffusion layers 608 and 610 include the same features as the performance enhancing layers described in PCT App. No. PCT/CA2010/002026 which was published as PCT Publication No. WO2011/079378 on Jul. 7, 2011, the entire disclosure of which is incorporated herein by reference. In some embodiments, diffusion layers 608 and 610 are made of carbon fiber papers or out of a combination of conductive materials and a binder.

Fuel cell assembly 600 also includes anode current collection and cover layer 614 and cathode current collection and cover layer 616 disposed on the outer surfaces of the anode gas diffusion layers 608, the cathode gas diffusion layers 610, and the electrolyte layer 606. Anode current collection and cover layer 614 includes anode current collecting circuit 618 and anode dielectric porous cover layer 628. Cathode current collection and cover layer 616 includes cathode current collection circuit 620 and cathode dielectric porous cover layer 630. As in assembly 100 in FIG. 1A, current collecting circuits 618 and 620 of assembly 600 are connected to an external portion of an electrical circuit in order to extract the current produced by planar array 604, such as a circuit providing power to an electronic device. Anode and cathode dielectric porous cover layers 628 and 630 envelope and contact each unit fuel cell 602. Portions 615 and 617 of layers 628 and 630, respectively, may extend between and interdigitate unit fuel cells 602.

In some embodiments, insulating material portions 612 may be thicker than electrolyte layer 606 and extend between and separate one or both of gas diffusion layers 608 and 610. FIG. 7 illustrates an embodiment of the invention that includes fuel cell assembly 700 that is identical to fuel cell assembly 600 in all ways except that fuel cell assembly 700 includes thicker insulating material portions 712 that extend and separate gas diffusion layers 708 and 710 as well as each of the electrolyte layers 706. In this way, cover layers 728 and 730 do not have portions that extend between neighboring unit fuel cells of planar array 704.

In still further embodiments, one or both of the anode and cathode cover layers may be formed from a paper-like porous material incorporating both hydrophilic and hydrophobic regions. During manufacture, the hydrophilic areas can be aligned with the geometry of the current collecting circuits to facilitate disposing of the electrically conductive paths of the circuits while the hydrophobic areas may be aligned with portions of the cover layers intended to be electrically insulating.

In yet further embodiments, one or both of the anode and cathode cover layers are formed into predetermined geometric shapes or patterns. For example, the anode and/or cathode cover layers can be formed such that their respective hydrophilic and hydrophobic regions are aligned in a striped pattern. Such patterns can be made by selective treatment of a hydrophobic polymer material to render it hydrophilic, for example, or, vice versa, by selective treatment of a paper-like hydrophilic material to render it hydrophobic. In a similar way, portions of the anode and cathode cover layers may be selectively treated to alter other properties (e.g. porosity, surface roughness, etc) to promote bonding of electrical paths to desired areas of one or both of the anode and cathode cover layers.

The current collecting circuits may be formed of conductive metals, for example Ag, Cu , Ni, Ti , Au, Pd , Pt, Al , other conductive materials, such as carbon, or alloys or combinations thereof, or a composite of a plurality of layers of conductive material. In some embodiments, a current collecting circuit may be formed of a copper layer of 17-70 microns in thickness. During operation, the current collecting circuits may be exposed to a number of different materials and chemical species, so the material used to form the current collecting circuits should be chosen to reduce or eliminate undesired reactions (e.g., to eliminate or reduce corrosion of the current collecting circuit and/or other portions of the fuel cell array). In some embodiments, the current collecting circuit may be formed from more than one material. For example, the current collecting circuits may include a copper layer that is coated with one or more conductive materials (e.g., a noble metal) that do not excessively react with the chemical species used and created by the electrochemical fuel cell reaction. Further, different portions of the current collector may include dissimilar materials. For example, a portion of the current collecting circuit situated in or contacting the anode and cathode cover layers may be covered with a one or more layers of a protective, conductive material such as a noble metal (e.g., gold), a waterproof lacquer, or an anodized material (e.g., aluminium). In some embodiments, these protective layers of the current collecting circuit can be formed by deposition through the porous material of one or both of the anode and cathode cover layers.

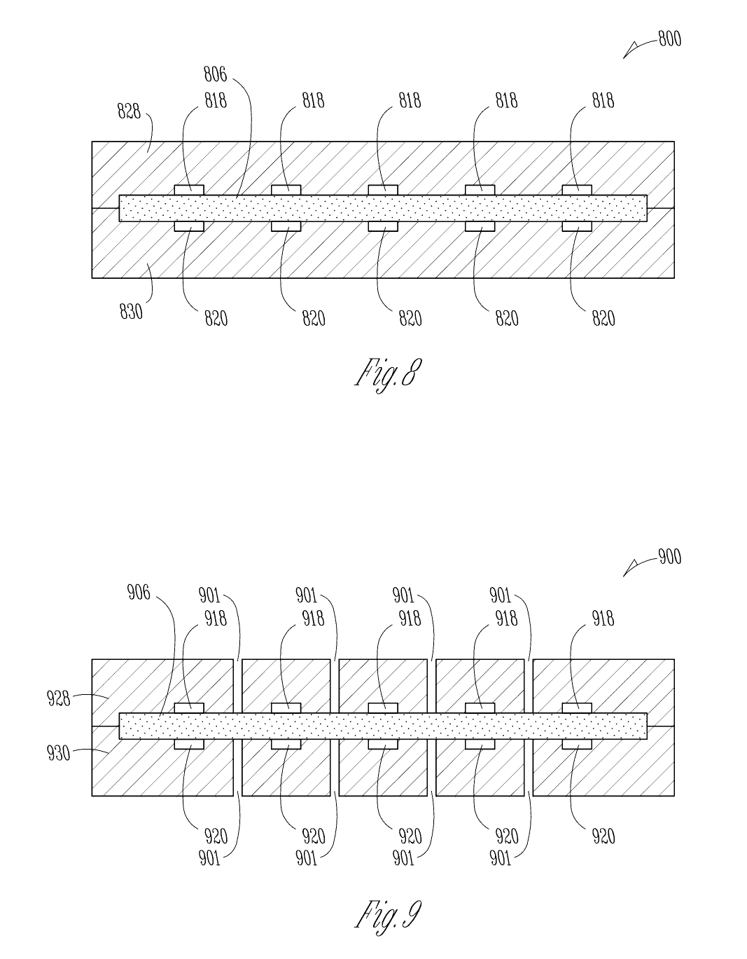

In still further embodiments, one or both of the anode and cathode gas diffusion layers may be omitted and the anode and cathode cover layers may be disposed directly onto the electrolyte layer. FIG. 8 illustrates such an embodiment in the form of fuel cell array 800. Fuel cell array 800 includes electrolyte layer 806, anode cover layer 828, and cathode cover layer 830. Anode cover layer 828 includes anode current collecting circuit 818 and cathode cover layer 830 includes cathode current collecting circuit 820. Portions of anode and cathode current collecting circuits 818 and 820 are positioned between their respective cover layers 828 and 830 and a major face of electrolyte layer 806. Rather than include discreet anode and cathode diffusion layers, the electrode materials for the anode and cathode electrodes are selectively deposited in portions of the anode and cathode cover layers 828 and 830 and/or in electrolyte layer 806 to form an array of unit fuel cells with one of each of the unit cells located under or adjacent each portion of anode and cathode current collecting circuits 818 and 830. The anode and cathode cover layers 828 and 830 perform a plurality of functions, including ensuring effective diffusion of the reactants to the active areas of the fuel cells and electronic conduction.

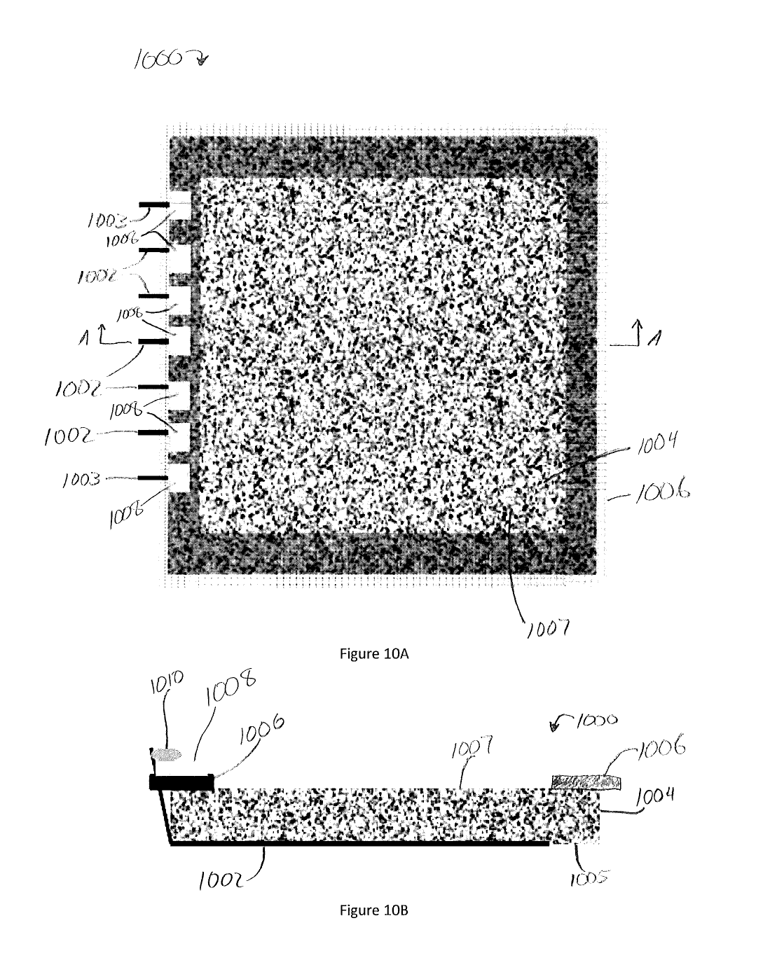

In some embodiments, portions of the anode and cathode cover layers that are located between the active areas of the anode and cathode electrodes may be removed or omitted. FIG. 9 illustrates such an embodiment in the form of fuel cell array 900. Fuel cell array 900 is similar in most regards to fuel cell array 800 illustrated in FIG. 8 and includes electrolyte layer 906, anode cover layer 928, and cathode cover layer 930. Anode and cathode cover layers 928 and 930 respectively include anode and cathode current collecting circuits 918 and 920. Electrode materials for the anode and cathode electrodes are selectively deposited in portions of anode and cathode cover layers 828 and 830 and/or in electrolyte layer 806 to form a series of unit fuel cell active areas under or adjacent to each of current collectors 918 and 920. The main difference between fuel cell array 900 and fuel cell array 800 is that portions of cover layers 928 and 930 have been removed or omitted to form spaces 901 overlaying areas of electrolyte layer 806 that do not form active areas of a unit fuel cell. Anode and cathode cover layers 228 and 230 may include a conductive porous material (e.g., carbon fiber paper or any other commonly utilized gas diffusion layer materials).

The above description is intended to be illustrative, and not restrictive. Other embodiments can be used, such as by one of ordinary skill in the art upon reviewing the above description. For example, elements of one described embodiment may be used in conjunction with elements from other described embodiments. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled. Further, while many of the embodiments described herein only illustrate three unit fuel cells, it will be appreciated that the various embodiments of the invention may include more or fewer unit fuel cells (for example the various embodiments may be constructed to have dozens, hundreds, or even thousands of unit cells or any number of unit cells between 1 and 100,000).

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

What is claimed is:

1. A fuel cell assembly, comprising:
a planar array of unit fuel cells, each unit fuel cell including
an electrolyte layer,
a first electrode disposed on a first side of the electrolyte layer, and
a second electrode disposed on a second side of the
electrolyte layer opposite the first side of the electrolyte layer;
a first dielectric cover layer disposed over a first side of the planar array;
a second dielectric cover layer disposed over a second side of the planar array opposite the first side of the planar array, wherein the first dielectric cover layer and the second dielectric cover layer both define a network of interconnected pores; and
a first portion of a current collecting component disposed on the first dielectric cover layer and in electrical communication with the planar array, wherein the first portion of a current collecting circuit contacts the first electrode of a plurality of the unit fuel cells; and
a second portion of a current collecting circuit disposed between the second dielectric cover layer and the planar array, wherein the second portion of a current collecting circuit contacts the second gas electrode of a plurality of the unit fuel cells.

2. The fuel cell assembly of claim 1, wherein the planar array includes a single continuous portion of material that forms the electrolyte layer of each unit fuel cell.

3. The fuel cell assembly of claim 1, wherein the planar array includes a plurality of insulating material layers disposed between neighboring unit fuel cells.

4. The fuel cell assembly of claim 1, wherein each unit fuel cell further includes a catalyst material.

5. The fuel cell assembly of claim 4, wherein the catalyst material is disposed as a catalyst layer between the electrolyte layer and the first electrode.

6. The fuel cell assembly of claim 4, wherein the catalyst material is located within the first electrode.

7. The fuel cell assembly of claim 1, wherein the first dielectric cover layer and the second dielectric cover layer are formed from a single sheet of material.

8. The fuel cell assembly of claim 1, wherein the first and second dielectric cover layers are formed from a material that does not substantially shrink or expand when exposed to water vapor, substantially shrink or expand in response to changes of temperatures within a range of about −40° C. to about 120° C., and does not substantially corrode when exposed to an acidic environment.

9. The fuel cell assembly of claim 1, wherein the first dielectric cover layer is bonded to the first side of the planar array and the second dielectric cover layer is bonded to the second side of the planar array.

10. The fuel cell assembly of claim 1, wherein a first portion of a current collecting circuit is bonded to the first dielectric cover layer and a second portion of a current collecting circuit is bonded to the second dielectric cover layer.

11. The fuel cell assembly of claim 1, wherein the current collecting circuit includes a wire, a trace on a PCB, or a ribbon.

12. The fuel cell assembly of claim 1, wherein the first electrode is made of carbon fiber paper or a combination of an electrically conductive material and a binder.

13. The fuel cell assembly of claim 1, further including a gasket surrounding an outer perimeter of the first dielectric cover layer.

14. The fuel cell assembly of claim 1, wherein the first dielectric cover layer is between about 100 μm and about 200 μm thick.

15. The fuel cell assembly of claim 1, wherein the first dielectric cover layer is thinner than the second dielectric cover layer.

16. The fuel cell assembly of claim 1, wherein the interconnected pores of the first dielectric cover layer make up between about 80% and about 90% of the total volume of the first dielectric cover layer.

17. The fuel cell assembly of claim 1, wherein the network of interconnected pores has an average pore size of less than 100 μm.

18. The fuel cell assembly of claim 1, wherein the first dielectric cover layer is less porous than the second dielectric cover layer.

19. A method of producing electricity, comprising:
providing the fuel cell assembly of claim 1;
directing a fuel through the first dielectric cover layer and into contact with the first electrode; and
directing an oxidant through the second dielectric cover layer and into contact with the second electrode.

20. A method of making a fuel cell assembly, comprising:
providing a planar array of unit fuel cells by disposing a first electrode layer on a first side of an electrolyte layer and disposing a second electrode layer on a second side of the electrolyte layer opposite the first side of the electrolyte layer;
disposing a first portion of a current collecting circuit on the first electrode layer, wherein the first portion of the current collecting circuit contacts the first electrode layer of a plurality of the unit fuel cells;
disposing a second portion of a current collecting circuit on the second electrode layer, wherein the second portion of the current collecting circuit contacts the second electrode layer of a plurality of the unit fuel cells;
disposing a first dielectric cover layer over a first side of the planar array; and
disposing a second dielectric cover layer over a second side of the planar array opposite the first side of the planar array, wherein the first dielectric cover layer and the second dielectric cover layer both define a network of interconnected pores.

21. The method of claim 20, wherein each unit fuel cell further includes a catalyst material.

22. The method of claim 20, wherein the first dielectric cover layer and the second dielectric cover layer are formed from a single sheet of material and disposing the first dielectric cover layer and disposing the second dielectric cover layer includes folding the single sheet of material around the planar array.

23. The method of claim 20, wherein disposing the first dielectric cover layer includes bonding the first dielectric cover layer to the first side of the planar array.

24. The method of claim 20, wherein disposing the first portion of a current collecting circuit includes bonding the first portion of a current collecting circuit to the first dielectric cover layer.
